(19) United States
(12) Patent Application Publication
(10) Pub. No.: US 2026/0232531 A1
(43) Pub. Date: Aug. 13, 2026

(54) ADAPTER DEVICE FOR COUPLING TO A MEDICAL VIAL

(71) Applicant: B. Braun Melsungen AG, Melsungen (DE)

(72) Inventors: Johannes Bolz, Kassel (DE); Florin Kopp, Schortens (DE); Christian Walter, Kassel (DE); Lara Berthold, Edertal (DE)

(21) Appl. No.: 19/154,540

(22) PCT Filed: Feb. 5, 2024
(86) PCT No.: PCT/EP2024/052732

§ 371 Date: Aug. 7, 2025

(30) Foreign Application Priority Data
Feb. 10, 2023 (DE) 10 2023 201 096.8

(51) Int. Cl. A61J 1/20

(52) U.S. Cl. CPC A61J 1/2055

(57) ABSTRACT

An adapter device for coupling to a medical vial has a main part and spring arms. A first spring arm section and second spring arm section are movable together. A locking section is arranged in the region of a free end face on the inner edge of the second spring arm section. The first spring arm section tapers from the fixed end toward the free end face. The inner edge of the second spring arm section runs radially inwardly in the circumferential direction from the fixed end toward the end face at an increasing radial distance to the outer edge of the second spring arm section. The second spring arm section has a first radial dimension in the region of the fixed end and a larger second radial dimension in the region of the locking section. The adapter device can be used for infusion therapy.

### CROSS-REFERENCE TO RELATED APPLICATIONS

This application is the United States national phase entry of International Application No. PCT/EP2024/052732, filed on Feb. 5, 2024, and claims priority to German Application No. 10 2023 201 096.8, filed on Feb. 10, 2023. The contents of International Application No. PCT/EP2024/052732 and German Application No. 10 2023 201 096.8 are incorporated by reference herein in their entireties.

### FIELD

The invention relates to an adapter device for coupling to a medical vial, having a main body with an axial central longitudinal axis, a radial direction oriented orthogonally to the central longitudinal axis, and a circumferential direction oriented about the central longitudinal axis, a plurality of spring arms, which are arranged on the main body in a manner offset from one another in the circumferential direction and each have at least a first spring arm portion, a second spring arm portion and a latching portion, wherein the first spring arm portion extends in the circumferential direction between a fixed end, firmly connected to the main body, and a free front end and is at least radially movable in a spring-elastic manner relative to the central longitudinal axis, wherein the second spring arm portion extends between an outer edge, lying radially outward and firmly connected to the first spring arm portion, and a radially inward free inner edge and is movable at least together with the first spring arm portion relative to the central longitudinal axis, and wherein the latching portion is arranged in the region of the free front end at the inner edge of the second spring arm portion and/or formed by same and is configured to latch with a closure cap of the medical vial.

### BACKGROUND

Such an adapter device is known from DE 10 2020 210 898 A1. The known adapter device has a main body with two spring arms offset from each other in the circumferential direction. The spring arms each have a first spring arm portion, a second spring arm portion and a latching portion. The first spring arm portions are each firmly connected at one end to the main body and are free at the other end, i.e. not connected to the main body. The second spring arm portions each have a radially outward outer edge and a radially inward inner edge. The outer edges are firmly connected to the respective first spring arm portion. The inner edges are free and each form one of the latching portions. The latching portions are each configured to latch with a closure cap of the vial that is to be coupled. For coupling purposes, the spring arms are resiliently movable radially inward and outward relative to an axial central longitudinal axis of the main body. In the known adapter device, the first spring arm portions, starting from their fixed end, are each L-shaped, the smallest axial dimension being in the region of the respective fixed end. The second spring arm portions are each designed in the form of a hook curved with respect to the central longitudinal axis. The inner edges and the outer edges are substantially parallel to each other. In addition, the second spring arm portions each take up only a comparatively small proportion of the total length of the first spring arm portions.

### SUMMARY

The object of the invention is to make available an adapter device of the type mentioned at the outset, which has improved properties compared to the prior art and which in particular allows simple and reliable coupling.

This object is achieved by the fact that the first spring arm portion, starting from its fixed end, tapers axially in the circumferential direction in the direction of its free front end, as a result of which the fixed end has a first axial dimension and the front end has a smaller, second axial dimension. Alternatively or additionally, the object is also achieved by the fact that the outer edge and the inner edge of the second spring arm portion extend substantially over an entire length of the first spring arm portion along the circumferential direction, wherein the inner edge, starting from the fixed end, extends radially inward in the circumferential direction in the direction of the front end, with an increasing radial distance from the outer edge, as a result of which the second spring arm portion, in the region of the fixed end, has a first radial dimension and, in the region of the latching portion, has a larger, second radial dimension. By virtue of the inventive design of the first spring arm portion and of the second spring arm portion and also the arrangement of the latching portion, a particularly advantageous elastic deformation behavior of the spring arms is achieved. This advantageous elastic deformation behavior allows simple and reliable coupling to the medical vial. For coupling it to the adapter device, the medical vial is moved, with its closure cap first, along the central longitudinal axis of the main body against the spring arms. Under the effect of the closure cap, the spring arms yield elastically. During this yielding movement, the first spring arm portions each move radially outward in a spring-elastic manner in relation to the central longitudinal axis. The second spring arm portions, firmly connected to the first spring arm portions, move together with the respective first spring arm portion. The same applies mutatis mutandis to the latching portions arranged and/or formed on the second spring arm portions. In embodiments of the invention, an axial and/or radial spring-elastic movement of the second spring arm portions relative to the respective first spring arm portion additionally takes place. The inventive design of the first spring arm portions tapering in the circumferential direction in particular enables particularly advantageous spring-elastic mobility in the radial direction. At the same time, sufficient mechanical stability and load capacity of the first spring arm portions are ensured. By virtue of the inventive arrangement and/or design of the second spring arm portions, a torsional deformation can be generated in addition to the radial deformation component of the spring arms. On the one hand, this torsional component of the deformation allows simplified coupling under comparatively reduced axial forces. On the other hand, said torsional component generates a kind of self-reinforcing of the latching connection between the closure cap and the latching portions, so that unwanted decoupling of the vial can be counteracted. The positional and/or directional information used in this description can be understood as follows: “inner” means, in relation to the radial direction, to the inside and thus closer to the central longitudinal axis. “outer” means, in relation to the radial direction, to the outside and thus farther away from the central longitudinal axis. Terms such as “inner edge”, “inner face”, “outer edge”, “outer face” or the like should be understood accordingly. It is further assumed that, in order to couple it to the adapter device, the vial is joined to the adapter device along the central longitudinal axis from the top downward. Terms such as “top”, “bottom”, “upper edge”, “lower edge”, “top face”, “bottom face” or the like should be understood accordingly. The medical vial to be coupled is a container for medical substances in a liquid or dry state, as they are used and generally known in the field of human or veterinary medicine. The design and function of such medical vials is sufficiently familiar to those skilled in the art, and therefore further explanations of these are not needed. Preferably, the vial to be coupled complies with the standards ISO 8362-1 and/or ISO 8536-1. It will be understood that the vial to be coupled is not a constituent part of the adapter device according to the invention. Preferably, the adapter device is configured for coupling to medical vials of different sizes. Different sizes means in particular with different diameters, especially of the respective closure cap. In this case, for coupling to vials of different sizes, the spring arms are resiliently movable to different extents. Where features are explained in this description only with respect to one/the spring arm, one/the first spring arm portion, one/the second spring arm portion and one/the latching portion, what is said applies preferably and mutatis mutandis to all of the spring arms and portions.

In an embodiment of the invention, the latching portions are each spaced apart by a first lever arm length, extending in the circumferential direction, from the respective fixed end and, in the radial direction, by a second lever arm length from the respective fixed end, as a result of which the spring arms, under the effect of an axial force on the respective latching portion, are torsionally movable and flexurally movable with spring elasticity in the manner of a torsion-flexion spring. In this way, a particularly advantageous deformation behavior of the spring arms is achieved. During the coupling of the vial to the adapter device, the lever arms, under the effect of the closure cap, perform a torsional movement, directed about their respective longitudinal axis extending in the circumferential direction, and at the same time a radially outwardly directed (longitudinal) bending movement. If unintentional pulling of the vial takes place in the coupled state, the resulting deformation behavior of the spring arms counteracts an unintentional release of the latching connection between the latching portions and the closure cap and thus unintentional decoupling of the vial. This is because the axial tensile load causes an opposite torsional movement of the spring arms, which is accompanied by a radially inwardly directed displacement and/or force component, as a result of which a kind of self-reinforcing of the latching connection can be achieved.

In a further embodiment of the invention, exactly three spring arms are present and each extend in the circumferential direction over at least 90°, preferably at least 100°, particularly preferably at least 110°. Due to the number of exactly three spring arms and accordingly also three latching portions, a statically determined coupling of the closure cap/vial is made possible. By virtue of the spring arms extending about the aforementioned angles, the greatest possible length is achieved. This further improves the elastic deformation behavior of the spring arms.

In a further embodiment of the invention, the latching portions, each in the form of a projection, protrude radially inward from the respective inner edge, wherein the projections each occupy a maximum of 15%, preferably a maximum of 10%, particularly preferably a maximum of 5%, of a total length of the respective inner edge. In other words, the latching portions are relatively short compared to the total length of the respective inner edge and thus also of the entire respective spring arm. The inventors have recognized that a further improved deformation behavior of the spring arms can thus be achieved and, in conjunction with this, particularly simple and reliable coupling of the vial can be supported.

In a further embodiment of the invention, the main body has a plurality of strut portions arranged in a manner offset from one another in the circumferential direction and each extending axially, wherein the plurality of spring arms each extend in the circumferential direction between two adjacent strut portions and at one end are firmly connected with their respective fixed end to one of the strut portions. In this way, a design of the main body is achieved that saves material and yet has a sufficient load capacity. Furthermore, compared to a fundamentally conceivable design in which the main body is closed in the circumferential direction, an improved view of the closure cap held between the spring arms is made possible. This makes it easier for medical personnel to identify incomplete and non-compliant coupling. Preferably, the number of the plurality of strut portions corresponds to the number of the plurality of spring arms. If, for example, there are exactly three spring arms, then there are also exactly three strut portions.

In a further embodiment of the invention, the main body has a stop portion, wherein the spring arms, in a state of the adapter device coupled to the vial, are each moved radially outward relative to the stop portion in a spring-elastic manner and engage behind the stop portion. As a result, under the effect of an upwardly directed decoupling axial force, the spring arms are axially and form-fittingly engaged and supported on the stop portion. Unintentional decoupling can be additionally counteracted in this way. The stop portion preferably lies above the spring arms with respect to the central longitudinal axis. If the main body has a plurality of strut portions, the stop portion is arranged above the spring arms preferably at one end of the strut portions, in particular completely. Preferably, the stop portion additionally acts as a mechanically load-bearing connection structure between the strut portions. In this case, the stop portion has a particularly advantageous multiple function, so that it is possible to dispense with separate functional portions for supporting the spring arms on the one hand and for reinforcing the strut portions on the other. The resulting functional integration enables a particularly simple configuration of the adapter device.

In a further embodiment of the invention, the stop portion is a ring portion closed in the circumferential direction and with a circular basic shape. Preferably, the ring portion is coaxial to the central longitudinal axis. Further preferably, the ring portion can have an axially upper contact geometry, which is configured for sliding interaction with the closure cap and allows simplified insertion of the latter between the spring arms. Preferably, the contact geometry is inclined radially inward in the direction of the central longitudinal axis, axially from the top downward. In other words, the ring portion and/or its contact geometry preferably forms a kind of funnel for simplified insertion of the closure cap.

In a further embodiment of the invention, the first spring arm portions each have an axially upper top face and an axially opposite bottom face, wherein the second spring arm portions are each arranged at the top face of the respective first spring arm portion and protrude radially inward from the top face. During coupling, the top face of the closure cap is facing axially. In comparison to a fundamentally conceivable and possible arrangement of the second spring arm portions on the bottom face of the respective first spring arm portion, this enables a further improved deformation behavior of the spring arms.

In a further embodiment of the invention, the top faces of the first spring arm portions each extend substantially parallel to the circumferential direction and parallel to the radial direction, and the bottom faces of the first spring arm portions each extend in the circumferential direction and in the axial direction and thus obliquely. In other words, the top faces and the bottom faces do not extend parallel to each other; starting from the fixed end, the bottom faces are inclined from the bottom upward in the direction of the respective front end in relation to the central longitudinal axis. The inventors have recognized that a further improved deformation behavior of the spring arms can be achieved in this way.

In a further embodiment of the invention, the second spring arm portions each have an axially upper top face with a convexly and/or radially inwardly inclined contact surface. This allows easy and smooth insertion of the closure cap between the spring arms. During coupling, the top face of the closure cap is facing axially. Under the axial action of the closure cap, the convex and/or radially inclined design of the contact surface generates a radial movement and/or force component. This further supports an elastic deformation behavior of the spring arms in accordance with the requirements. In addition, the convex and/or radially inwardly inclined design of the contact surface forms a kind of funnel for the closure cap. This makes it particularly easy to insert it between the spring arms.

In a further embodiment of the invention, the first spring arm portions each have a substantially constant radial wall thickness and/or the second spring arm portions each have a substantially constant axial wall thickness. The first spring arm portions each have a radially outward outer face and a radially inward inner face. The radial wall thickness extends between the inner face and the outer face. The second spring arm portions each have the abovementioned upper top face, with respect to the central longitudinal axis, and an axially opposite bottom face. The axial wall thickness of the second spring arm portions extends between the respective top face and bottom face. The inventors have recognized that a further improved deformation behavior of the spring arms can be achieved by a constant wall thickness of the first spring arm portions and/or of the second spring arm portions.

### BRIEF DESCRIPTION OF THE DRAWINGS

Further advantages and features of the invention will become apparent from the following description of a preferred exemplary embodiment of the invention, which is illustrated by means of the drawings.

FIG. 1 shows a schematic perspective representation of an embodiment of an adapter device according to the invention;

FIG. 2 shows the adapter device according to FIG. 1 in a schematic side view, in a radial viewing direction;

FIG. 3 shows the adapter device according to FIGS. 1 and 2 in a schematic plan view, in an axial viewing direction;

FIG. 4 shows the adapter device according to FIGS. 1 to 3 in a perspective sectional representation along an axial central longitudinal plane;

FIG. 5 shows the sectional representation according to FIG. 4, in a viewing direction radially from the inside outward;

FIG. 6 shows a schematic and greatly simplified exploded representation of a spring arm of the adapter device according to FIGS. 1 to 5, with individual portions of the spring arm being shown in different viewing directions; and

FIG. 7 shows the adapter device according to FIGS. 1 to 5 in an exemplary use situation during coupling to a medical vial.

### DETAILED DESCRIPTION

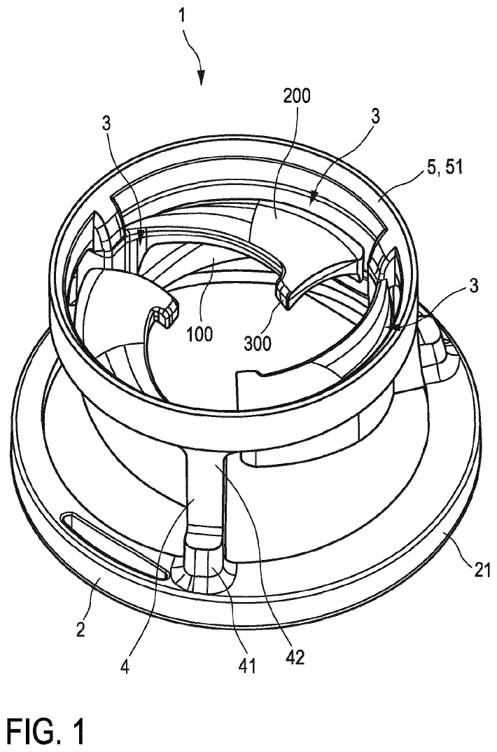

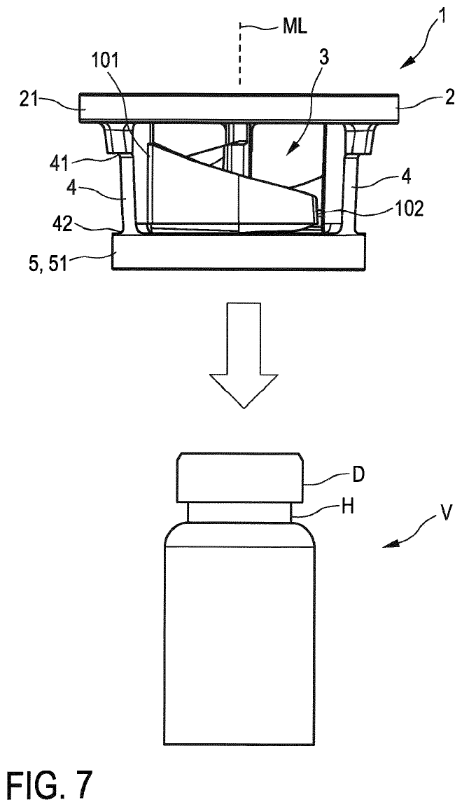

According to FIGS. 1 to 7, an adapter device 1 is configured for coupling to a medical vial V (see FIG. 7).

In the present case, the vial V to be coupled complies with ISO 8362-1 and/or ISO 8536-1. Vials are used for storing medical substances in liquid or dry form and are generally known in human and/or veterinary medicine. Vials are also sometimes known as “ampules”, “phials” or “pierceable injection bottles”. Vials are usually available in different standardized sizes, with vials of different sizes having different capacities and therefore different (standardized) dimensions. The vial V shown in FIG. 7 has a closure cap D, which is mounted in a known manner fluid-tight on a neck region H of the vial V. The dimensions of the closure cap D and of the neck region H are also standardized. In addition, the closure cap D can also be called a “closure lid” or “crimped cap”. As the basic structure and function of the vial V are generally known to a person skilled in the art, further explanations can be omitted.

The adapter device 1 has a main body 2 and a plurality of spring arms 3.

In the embodiment shown, the adapter device 1 also has a plurality of strut portions 4 and a stop portion 5. The strut portions 4 and the stop portion 5 are optional and are therefore not present in every embodiment.

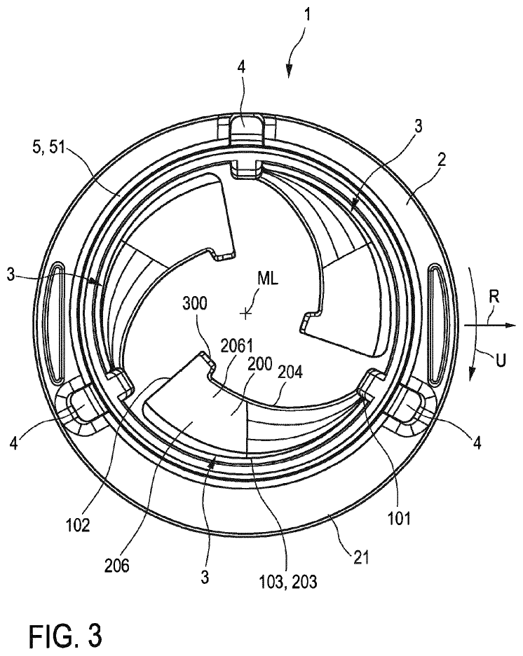

The main body 2 has an axially oriented central longitudinal axis ML, a radial direction R oriented orthogonally to the central longitudinal axis ML, and a circumferential direction U oriented about the central longitudinal axis ML (see in particular FIG. 3).

The plurality of spring arms 3 are arranged on the main body 2 in a manner offset from one another along the circumferential direction U and/or about the central longitudinal axis ML. In the embodiment shown, the spring arms 3 are uniformly offset.

The plurality of spring arms 3 have an identical design and function in the embodiment shown. Where further features are explained below only in relation to one of the plurality of spring arms 3, what has been said also applies, mutatis mutandis, to the further spring arms.

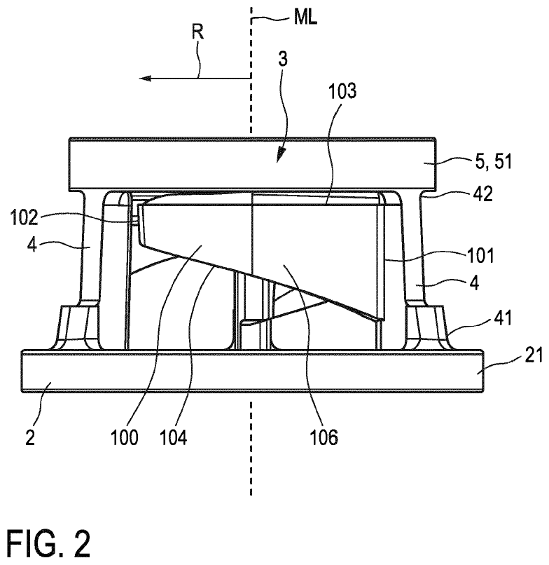

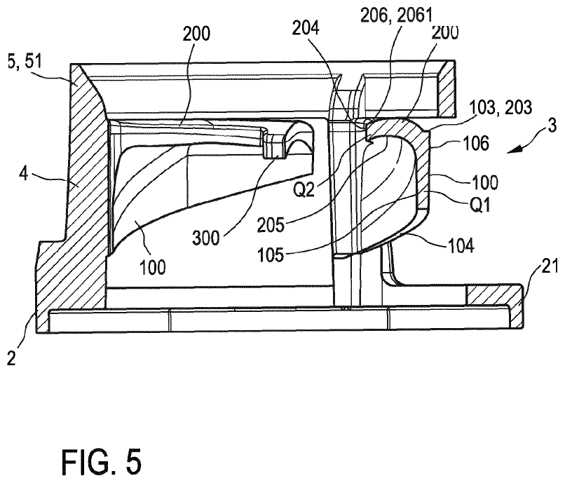

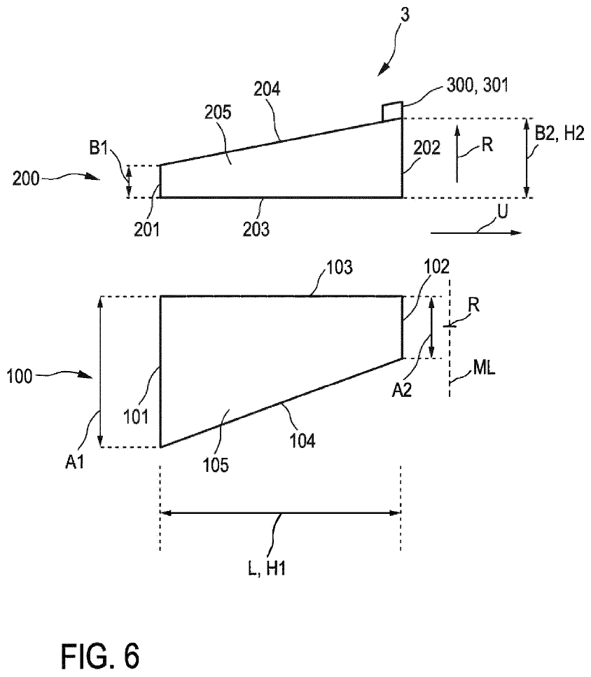

The spring arms 3 each have a first spring arm portion 100, a second spring arm portion 200, and a latching portion 300, as is shown in particular in FIGS. 1 and 6. For better clarification of the respective features, different portions of the spring arm 3 in FIG. 6 are shown in different viewing directions. The first spring arm portion 100 is shown in a viewing direction radially from the inside outward. The second spring arm portion 200 and the third spring arm portion 300 are shown in a viewing direction axially along the central longitudinal axis ML. With respect to the drawing planes of FIGS. 2 and 5, the viewing direction here is from the bottom upward along the central longitudinal axis ML and thus to a bottom face 205 of the second spring arm portion 200.

The first spring arm portion 100 extends along the circumferential direction U and/or about the central longitudinal axis ML between a fixed end 101 and a front end 102. In the embodiment shown, the first spring arm portion 100 curves concentrically about the central longitudinal axis ML. The fixed end 101 is firmly connected to the main body 2. The front end 102 is not directly connected to the main body 2 and is accordingly “free”. The first spring arm portion 100 is elastically resiliently movable relative to the central longitudinal axis ML at least in the radial direction R. In the present case, the elastic spring movement is possible both radially inward and outward. The first spring arm portion 100 also has an axially upper top face 103 and, along the central longitudinal axis ML, an opposite bottom face 104. Furthermore, the first spring arm portion 100 has a radially inward inner face 105 and a radially outward outer face 106.

The second spring arm portion 200 has a radially outward outer edge 203 and a radially inward inner edge 204. The outer edge 203 is firmly connected to the first spring arm portion 100. The inner edge 204 is not directly connected to the first spring arm portion 100 and is accordingly “free”. The second spring arm portion 200 is movable at least together with the first spring arm portion 100 relative to the central longitudinal axis ML. The second spring arm portion 200 furthermore extends along the circumferential direction U and/or about the central longitudinal axis ML between a first front end 201 and a second front end 202. Furthermore, the second spring arm portion 200 has the abovementioned bottom face 205 and, along the central longitudinal axis ML, an opposite top face 206.

The latching portion 300 is arranged in the region of the free front end 102 on the inner edge 204 and/or is formed by same. The latching portion 300 is configured to latch with the closure cap D and/or the neck region H of the vial V. In the latched state, the latching portion 300 engages axially behind the closure cap D and bears on the neck portion H.

For coupling it to the adapter device 1, the vial V is for example, and with respect to the drawing plane of FIG. 2, guided along the central longitudinal axis ML, with the closure cap D first, onto the main body 2. Alternatively and kinematically analogously, the adapter device 1 is guided onto the vial V as shown in FIG. 7. The closure cap D presses each of the spring arms 3 radially outward. As soon as the vial V is inserted axially far enough into the main body 2 and the closure cap D lies axially below the latching portions 300, the spring arms 3 spring radially inward and the latching portions 300 engage with the vial V.

In the use of the adapter device 1, simple and smooth coupling to the vial Vis desirable on the one hand, so that medical personnel do not have to apply excessive force. On the other hand, unwanted decoupling of the vial V and thus unintentional release of the latching connection should be reliably counteracted. The decisive factor for this is the elastic deformation behavior of the spring arms 3. In order to achieve or support an advantageous deformation behavior, the first spring arm portion 100 and/or the second spring arm portion 200 and/or the latching portion 300 are specifically designed and/or arranged as follows:

Starting from its fixed end 101, the first spring arm portion 100 axially tapers in the direction of its free front end 102 along the circumferential direction U, in other words about the central longitudinal axis ML. Thus, the fixed end 101 has a first axial dimension A1. The free front end 102 has a second axial dimension A2. Because of said tapering, the second axial dimension A2 is smaller than the first axial dimension A1. In the embodiment shown, the tapering is continuous and/or constant.

As regards the design of the second spring arm portion 200, it will be noted that its outer edge 203 and inner edge 204 extend substantially over an entire length L of the first spring arm portion along the circumferential direction U. In this case, starting from the fixed end 101 and/or the first front end 201, the inner edge 204 extends inward along the circumferential direction U and/or about the central longitudinal axis ML in the direction of the free front end 102 and/or the second front end 202, with an increasing radial distance from the outer edge 203. In this way, the second spring arm portion 200, in the region of its first front end 201 and thus also of the fixed end 101, has a first radial dimension B1. In the region of its second front end 201, and thus also of the latching portion 300 and/or the front end 102 of the first spring arm portion 100, the second spring arm portion 200 has a second radial dimension B2. The second radial dimension B2 is greater than the first radial dimension B1. In other words, the second spring arm portion 200 widens radially along the circumferential direction U in the direction of the latching portion 300.

Furthermore, with reference to FIG. 6, it is shown here that the latching portion 300 is spaced apart from the fixed end 101 by a first lever arm length H1 which extends in the circumferential direction U and which in the present case corresponds approximately to the length L of the first spring arm portion 100. In the radial direction R, the latching portion 300 is spaced apart from the fixed end 101 by a second lever arm length H2, wherein said second lever arm length H2 in the present case corresponds approximately to the second radial dimension B2 of the second spring arm portion 200. On account of said lever ratios of the latching portion 300 with respect to the fixed end 101, the spring arm 3, under the action of the closure cap D, behaves in the manner of a torsion-flexion spring. As a result, during the coupling process, the spring arm 3 is not only moved radially outward in a spring-elastic manner. In fact, a torsional movement about an unspecified longitudinal axis of the spring arm 3 additionally takes place. Furthermore, in the embodiment shown, the second spring arm portion 200 is at least slightly elastically deformed relative to the first spring arm portion 100. During the coupling to the vial V, this deformation occurs in an axially downward direction, i.e. the second spring arm portion 200 is at least slightly elastically bent downward axially relative to the first spring arm portion 100 before the latching portion 300 latches onto the neck region H.

In the embodiment shown, the latching portion 300 protrudes radially inward in the form of a projection 301 from the inner edge 204 of the second spring arm portion 200.

The projection 301 takes up only a comparatively small proportion of an unspecified total length of the inner edge 204. In the present case, said total length of the inner edge 204 corresponds approximately to the length L of the first spring arm portion 100. In the embodiment shown, the projection 301 occupies a maximum of 5% of the length L. In further embodiments, the projection 301 occupies a maximum of 10% or a maximum of 15% of the length L.

In the embodiment shown, the adapter device 1 has exactly three spring arms 3. The spring arms 3 each extend by approximately 110° about the central longitudinal axis ML. This is shown in particular in FIG. 3. In embodiments not shown in the figures, the spring arms extend by at least 90° or at least 100°.

In the embodiment shown, the main body 2 has exactly three strut portions 4. The strut portions 4 are arranged in a manner offset from one another along the circumferential direction U and/or about the central longitudinal axis ML. In the present case, the offset is uniform and is therefore 120°. The strut portions 4 each extend along the central longitudinal axis ML between a lower first end 41 and an upper second end 42 (see FIG. 1). In the present case, each one of the plurality of spring arms 3 is assigned to one of the plurality of strut portions 4 and vice versa. In this case, the spring arms 3 are each articulated at one end on one of the strut portions 4 and for this purpose are firmly connected to the respective strut portion 4. In particular, the fixed end 101 of the respective first spring arm portion 100 and thus also of the respective spring arm 3 is firmly connected to the strut portion 4. The same applies preferably to the first end 201 of the respective second spring arm portion 200.

As was explained at the outset, the strut portions 4 are optional. In an embodiment not shown in the figures, the main body 2 has, instead of the plurality of strut portions, a circumferentially closed wall, on the inner face of which the spring arms are arranged.

The optional stop portion 5 is arranged above the spring arms 3 with respect to the central longitudinal axis ML and allows a particularly reliable coupling of the vial V. In a state of the adapter device 1 coupled to the vial V, the spring arms 3 are each moved radially outward in a spring-elastic manner with respect to the central longitudinal axis ML and moved axially under the stop portion 5. Consequently, the spring arms 3 engage behind the stop portion 5. As a result, the mobility of the spring arms 3 is additionally stabilized against an axial pulling-out force, which acts along the central longitudinal axis ML from the bottom upward. In the present case, under the effect of said force, the spring arms 3 come to bear with axial form-fit engagement on the stop portion 5. This counteracts unwanted decoupling and/or release of the latching connection.

In the embodiment shown, the stop portion 5 is a ring portion 51 closed in the circumferential direction U. In the present case, the ring portion 51 has a circular basic shape and is coaxial to the central longitudinal axis ML.

The optional strut portions 4 are firmly connected at one end with their respective second end 42 to the stop portion 5, in this case the ring portion 51. At the other end, the strut portions 4 are each fastened with their first end 41 to a base portion 21 of the main body 2. The base portion 21 is to be understood as optional and also has a ring-shaped configuration in the present case. In the embodiment shown, the ring portion 51 simultaneously functions as a mechanically load-bearing structure for connecting the strut portions 4.

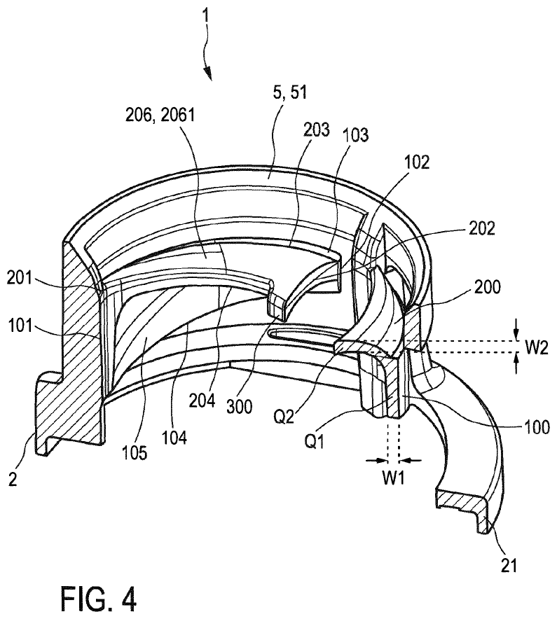

Furthermore, with respect in particular to FIGS. 5 and 6, the second spring arm portion 200 in the present case is arranged on the top face 103 of the first spring arm portion 100. Starting from the top face 103, the second spring arm portion 200 protrudes radially inward from the first spring arm portion 100. The resulting cross section of the spring arm 3 can be seen, for example, in FIGS. 4 and 5 and has an L-shape. A long leg of the L-shape is formed by a cross section Q1 of the first spring arm portion 100. A short leg is formed by a cross section Q2 of the second spring arm portion 200. Starting from the fixed end 101 in the direction of the free end 202, the first cross section Q1 decreases continuously, whereas the second cross section Q2 increases continuously. In other words, the long leg of the L-shape becomes increasingly shorter, whereas the short leg becomes increasingly longer.

In the present case, the top face 103 of the first spring arm portion 100 is substantially parallel to the circumferential direction and/or the radial direction. In other words, the top face 103 is substantially parallel to a radial plane of the main body 2. In contrast, the bottom face 104 extends obliquely. In this case, starting from the fixed end 101, the bottom face 104 extends along the circumferential direction U axially upward in the direction of the free end 102. This results in said tapering of the first spring arm portion 100.

The second spring arm portion 200 also has a top face 206 axially opposite the bottom face 205. The top face 206 has a convex and/or radially inwardly inclined contact surface 2061. The contact surface 2061 is configured for sliding interaction with the closure cap D. During coupling to the adapter device 1, the closure cap D comes to bear with its front end on the contact surface 2061. During a downward movement of the vial V (with respect to the situation shown in FIG. 7, there can also said to be kinematically analogously a downward movement of the adapter device 1), the closure cap D presses against the contact surface 2061, wherein the convex design and/or inward radial inclination thereof causes a radially outwardly directed reaction force of the contact force, which leads to improved radial deflection of the respective spring arm 3.

In the embodiment shown, the first spring arm portion has a substantially constant radial wall thickness W1 (see FIG. 4). The second spring arm portion has a substantially constant axial wall thickness W2.

In the embodiment shown, the entire adapter device 1 is made in one piece from plastic. Consequently, the first spring arm portion 100, the second spring arm portion 200 and the latching portion 300 are also in one continuous piece.

1.-11. (canceled)

12. An adapter device for coupling to a medical vial, the adapter device comprising:
a main body with a central longitudinal axis, a radial direction oriented orthogonally to the central longitudinal axis, and a circumferential direction oriented about the central longitudinal axis; and
a plurality of spring arms arranged on the main body in a manner offset from one another in the circumferential direction, each spring arm having at least a first spring arm portion, a second spring arm portion and a latching portion,
the first spring arm portion extending in the circumferential direction between a fixed end, firmly connected to the main body, and a free front end, the first spring arm portion being at least radially movable in a spring-elastic manner relative to the central longitudinal axis,
the second spring arm portion extending between an outer edge, lying radially outward and firmly connected to the first spring arm portion, and a radially inward free inner edge, the second spring arm portion being movable at least together with the first spring arm portion relative to the central longitudinal axis,
the latching portion being arranged in a region of the free front end at the radially inward free inner edge of the second spring arm portion and/or formed by the region of the free front end, the latching portion being configured to latch with a closure cap of the medical vial,
the first spring arm portion, starting from the fixed end, tapering axially in the circumferential direction toward the free front end, such that the fixed end has a first axial dimension and the free front end has a second axial dimension smaller than the first axial dimension,
the outer edge and the radially inward free inner edge of the second spring arm portion extending over an entire length of the first spring arm portion along the circumferential direction,
the radially inward free inner edge, starting from the fixed end, extending radially inwardly in the circumferential direction toward the free front end, with an increasing radial distance from the outer edge, such that the second spring arm portion, in the region of the fixed end, has a first radial dimension and, in the region of the latching portion, has a second radial dimension larger than the first radial dimension.

13. The adapter device according to claim 12, wherein the latching portions are spaced apart from one another by a first lever arm length extending in the circumferential direction from the respective fixed end and, in the radial direction, by a second lever arm length from the respective fixed end, such that the plurality of spring arms are torsionally movable and flexurally movable with spring elasticity in the manner of a torsion-flexion spring in response to an axial force on the respective latching portion.

14. The adapter device according to claim 12, wherein the plurality of spring arms consists of three spring arms, each of the three spring arms extending in the circumferential direction over at least 90°.

15. The adapter device according to claim 12, wherein the plurality of spring arms consists of three spring arms, each of the three spring arms extending in the circumferential direction over at least preferably at least 100°.

16. The adapter device according to claim 12, wherein the plurality of spring arms consists of three spring arms, each of the three spring arms extending in the circumferential direction over at least preferably at least 110°.

17. The adapter device according to claim 12, wherein:
each latching portion comprises a projection,
the latching portions protrude radially inwardly from the respective inner edge, and
the projections each occupy a maximum of 15% of a total length of the respective inner edge.

18. The adapter device according to claim 17, wherein the projections each occupy a maximum of 10% of a total length of the respective inner edge.

19. The adapter device according to claim 17, wherein the projections each occupy a maximum of 5% of a total length of the respective inner edge.

20. The adapter device according to claim 12, wherein the main body has a plurality of strut portions arranged in a manner offset from one another in the circumferential direction and each extending axially, wherein the plurality of spring arms each extend in the circumferential direction between two adjacent strut portions of the plurality of strut portions and are firmly connected at one end with their respective fixed end to one of the two adjacent strut portions.

21. The adapter device according to claim 12, wherein:
the main body has a stop portion, and
the plurality of spring arms are each moved radially outwardly relative to the stop portion in a spring-elastic manner and engage behind the stop portion when the adapter device is coupled to the vial.

22. The adapter device according to claim 21, wherein the stop portion is a ring portion closed in the circumferential direction and with a circular basic shape.

23. The adapter device according to claim 12, wherein:
the first spring arm portions each have an axially upper top face and an axially opposite bottom face, and
the second spring arm portions are each arranged on the top face of the respective first spring arm portion and protrude radially inwardly from the axially upper top face.

24. The adapter device according to claim 23, wherein:
the axially upper top faces of the first spring arm portions each extend parallel to the circumferential direction and parallel to the radial direction, and
the axially opposite bottom faces extend in the circumferential direction and along the central longitudinal axis and thus obliquely.

25. The adapter device according to claim 12, wherein the second spring arm portions each have an upper top face with a convexly and/or radially inwardly inclined contact surface.

26. The adapter device according to claim 12, wherein the first spring arm portions each have a constant radial wall thickness, and/or wherein the second spring arm portions each have a constant axial wall thickness.
